(19) United States
(12) Patent Application Publication
(10) Pub. No.: US 2013/0086502 A1
(43) Pub. Date: Apr. 4, 2013

(54) USER INTERFACE

(71) Applicant: Erkki Kalevi Rysa, Tampere (FI)

(72) Inventor: Erkki Kalevi Rysa, Tampere (FI)

(73) Assignee: NOKIA CORPORATION, Espoo (FI)

(21) Appl. No.: 13/250,471

(22) Filed: Sep. 30, 2011

(51) Int. Cl. G06F 3/048

(52) U.S. Cl. 715/773; 715/823

(57) ABSTRACT

An apparatus comprising:
at least one processor; and
at least one memory including computer program code,
the at least one memory and the computer program code configured to, with the at least one processor, cause the apparatus to perform at least the following:
enable selection of a constituent portion of a graphical user interface of an electronic device, the graphical user interface comprising a plurality of user interface elements, wherein the constituent portion is a subset of the plurality of user interface elements, the subset comprising multiple said user interface elements;
enlarge the user interface elements of the selected constituent portion of the graphical user interface; and
allow selection of a said enlarged user interface element.

### TECHNICAL FIELD

The present disclosure relates to the field of user interfaces, and the enlargement of user interface elements within them.

### BACKGROUND

A graphical user interface may enable a user to interact with an electronic device, for example, to open applications using application icons, to select menu items from a menu, or to enter characters using a virtual keypad. The user may interact with the graphical user interface directly (e.g. by using a stylus, such as a finger, on a touch screen) or indirectly (e.g. using a mouse to control a cursor).

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided an apparatus comprising:
at least one processor; and
at least one memory including computer program code,
the at least one memory and the computer program code configured to, with the at least one processor, cause the apparatus to perform at least the following:
enable selection of a constituent portion of a graphical user interface of an electronic device, the graphical user interface comprising a plurality of user interface elements, wherein the constituent portion is a subset of the plurality of user interface elements, the subset comprising multiple said user interface elements;
enlarge the user interface elements of the selected constituent portion of the graphical user interface; and
allow selection of a said enlarged user interface element.

The graphical user interface may comprise a combination of one or more of a virtual keyboard, a menu, a 1D array of user interface elements, a 2D array of user interface elements, and a 3D array of user interface elements.

The graphical user interface may be configured to enable character entry (e.g. to enable a textual message to be composed). A textual message may comprise, for example, a combination of one or more of a text message, an SMS message, an MMS message, an email, a search entry, a text document, a twitter post, a status update, a blog post, a calendar entry and a web address. A character may comprise a combination of one or more of a word, a letter character (e.g. from the Roman, Greek, Arabic or Cyrillic alphabets), a graphic character (e.g. a sinograph, Japanese kana or Korean delineation), a phrase, a syllable, a diacritical mark, an emoticon, and a punctuation mark. A keyboard or keypad may comprise an alphanumeric key input area, a numeric key input area, an AZERTY key input area, a QWERTY key input area or an ITU-T E.161 key input area.

A constituent portion may comprise a 1D array of user interface elements or a 2D (or 3D) array of user interface elements. The constituent portions may be predefined. For example, it may be predefined by the device which user interface elements form part of a particular constituent portion. A constituent portion may be defined by the user. For example, the user may define a constituent portion by selecting multiple user interface elements (e.g. by drawing a boundary around the icons making up the user defined constituent portion).

A said user interface element may comprise a key (e.g. corresponding to a character), an icon, or a menu item. A user interface element may correspond to one or more functions. For example, an application icon user interface element may be used to open the associated application. Also, a key user interface element may be used to enter one or more corresponding characters. Different corresponding functions of a user interface element may be associated with different respective user interactions (e.g. input gestures). For example, a key of a ITU-T E.161 predictive text keyboard may be associated with multiple characters (e.g. ‘A’, ‘B’, and ‘C’), wherein a single press user interaction would initiate entry of a first character (e.g. ‘A’), a double press user interaction would initiate entry of a second character (e.g. ‘B’) and a triple press interaction would initiate entry of a third character (e.g. ‘C’).

The size of the user interface element may be considered to correspond to the length or area bounded by the boundary of the user interface element. For example, a user interface element may comprise an area of the screen bounded by a boundary (the boundary may or may not be visible), such that the user may interact with the user interface element by interacting with the screen within the boundary. Enlarging the user interface element may be considered to be extending the boundary of a user interface element such that, for example, one or more of the area, length, width, height or other dimension enclosed by the boundary is increased. It will be appreciated that any indicia labelling the user interface element may or may not be enlarged.

The apparatus may be configured to:

reduce the size of the user interface elements which do not form part of the enlarged selected constituent portion of the graphical user interface element.

The apparatus may be configured to:

remove from view the user interface elements which do not form part of the selected constituent portion.

It will be appreciated that some or all of the enlarged user interface elements may be displayed on a display at the same time. For example, the user interface elements may be enlarged such that only a section of the selected constituent portion is visible. The user may view the non-displayed enlarged user interface elements by, for example, scrolling or other navigating commands.

The apparatus may be configured to:

enable selection of multiple said constituent portions of a graphical use interface.

The apparatus may be configured to:

adjust the size of the non-enlarged user interface elements such that all of the user interface elements visible before selection remain visible after selection and enlargement.

Constituent portions of the graphical user interface may or may not be mutually exclusive.

The relative positions of the user interface elements of the selected constituent portion may be the same before and after enlargement.

Selection of the constituent portion of the graphical user interface may comprise:
detecting a particular stylus position from a plurality of detectable stylus positions of the electronic device, each stylus position being associated with a constituent portion of the graphical user interface.

Selection of the constituent portion of the graphical user interface may comprise:
detecting a particular cursor position from a plurality of detectable cursor positions of the electronic device, each cursor position being associated with a constituent portion of the graphical user interface.

Selection of the constituent portion of the graphical user interface may comprise:
detecting an particular orientation from a plurality of detectable orientations of the electronic device, each orientation being associated with a constituent portion of the graphical user interface.

Selection of the constituent portion of the graphical user interface may comprise:
detecting a selection input.

Selection of the constituent portion of the graphical user interface may comprise:
detecting a tilt of the electronic device, from a plurality of detectable tilts of the electronic device, each tilt being associated with a constituent portion of the graphical user interface.

The graphical user interface may comprise one constituent portion or multiple constituent portions.

The user may interact with the graphical user interface directly (e.g. by using a stylus, such as a finger, on a touch screen) or indirectly (e.g. using a mouse, pointing stick, or wand to control a cursor).

The electronic device may be at least one of a portable electronic device, circuitry for a portable electronic device, a laptop computer, a desktop computer, a mobile phone, a Smartphone, a tablet PC, a monitor, a personal digital assistant or a digital camera or a module for the same.

The user interface may comprise a combination of one or more of a wand, a pointing stick, a touchpad, a touch-screen, a stylus and pad, a mouse, a physical keyboard, a virtual keyboard, a joystick, a remote controller, a button, a microphone, a motion detector, a position detector, a scriber and an accelerometer.

Memory may comprise one or more of, for example, a CD, a DVD, flash memory, a floppy disk, a hard disk, volatile memory, non-volatile memory Random Access Memory.

The apparatus may be connected/connectable to a network. The network may be, for example, the internet, a mobile phone network, a wireless network, LAN or Ethernet. The apparatus may comprise a transmitter and or receiver to interact with a network. The transmitter/receiver may comprise, for example, an antenna, an Ethernet port, a LAN connection, a USB port, a radio antenna, Bluetooth connector, infrared port, fibre optic detector/transmitter.

In a second aspect, there is provided a method, the method comprising:
enabling selection of a constituent portion of a graphical user interface of an electronic device, the graphical user interface comprising a plurality of user interface elements, wherein the constituent portion is a subset of the plurality of user interface elements, the subset comprising multiple said user interface elements;
enlarging the user interface elements of the selected constituent portion of the graphical user interface; and
allowing selection of a said enlarged user interface element.

In a third aspect, there is provided a computer program, the computer program comprising computer program code configured to:
enable selection of a constituent portion of a graphical user interface of an electronic device, the graphical user interface comprising a plurality of user interface elements, wherein the constituent portion is a subset of the plurality of user interface elements, the subset comprising multiple said user interface elements;
enlarge the user interface elements of the selected constituent portion of the graphical user interface; and
allow selection of a said enlarged user interface element.

The computer program may be stored on a storage media (e.g. on a CD, a DVD, a memory stick or other non-transitory medium). The computer program may be configured to run on a device or apparatus as an application. An application may be run by a device or apparatus via an operating system.

In a fourth aspect, there is provided an apparatus, the apparatus comprising:
means for enabling configured to enable selection of a constituent portion of a means for graphical user interfacing with an electronic device, the means for graphical user interfacing comprising a plurality of elemental means for user interfacing, wherein the constituent portion is a subset of the plurality of elemental means for user interfacing, the subset comprising multiple said elemental means for user interfacing;
means for enlarging configured to enlarge the elemental means for user interfacing of the selected constituent portion of the means for graphical user interfacing; and
means for selection configured to allow selection of a said enlarged elemental means for user interfacing.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

Example embodiments may be implemented devices such as portable electronic devices, e.g. so-called hand-portable electronic devices which may be hand-held in use (although they may be placed in a cradle in use). Such hand-portable electronic devices include so-called Personal Digital Assistants (PDAs) and tablet PCs.

The portable electronic devices/apparatus described herein may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

The above summary is intended to be merely exemplary and non-limiting.

### BRIEF DESCRIPTION OF THE FIGURES

A description is now given, by way of example only, with reference to the accompanying drawings, in which:

FIG. 1 depicts an embodiment comprising a number of electronic components, including memory, a processor and a communication unit.

FIG. 2 illustrates an example embodiment comprising a touch-screen.

FIG. 3a-3d depicts the example embodiment of FIG. 2 as the user is entering a telephone number.

FIG. 4a-4d depicts a further example embodiment as the user is entering a textual message.

FIG. 5a-5c depicts a further example embodiment as the user is selecting a particular icon user interface elements from a plurality of icon user interface elements.

FIG. 6 depicts a flow diagram describing the method used to select a constituent portion an enable selection of a user interface element.

FIG. 7 illustrates schematically a computer readable media providing a program according to an example embodiment of the present invention.

### DESCRIPTION OF EXAMPLE ASPECTS/EMBODIMENTS

Other example embodiments depicted in the figures have been provided with reference numerals that correspond to similar features of earlier described example embodiments. For example, feature number 1 can also correspond to numbers 101, 201, 301 etc. These numbered features may appear in the figures but may not have been directly referred to within the description of these particular example embodiments. These have still been provided in the figures to aid understanding of the further example embodiments, particularly in relation to the features of similar earlier described example embodiments.

It is common for an electronic device to have a user interface (which may or may not be graphically based) to allow a user to interact with the device. For example, the user may use a keyboard to enter text or icons to select and run applications.

Generally, the user interface elements of a user interface are configured such that they are large enough to be unambiguously interacted with by the user. For example, the keys on a physical keyboard are commensurate with the size of a user's finger. However, in order to make the interface as small as possible, or to display more information, the user interface elements may be reduced in size. This is particularly important with portable electronic devices. Therefore, designing an optimum user interface may involve making a compromise between ergonomic and functionality considerations.

Example embodiments contained herein may be considered to provide a way of allowing a constituent portion of a graphical user interface to be enlarged to allow selection of user interface elements of that (enlarged) constituent portion. It will be appreciated that this may allow the user interface as a whole to remain compact whilst allowing the user to interact easily with the individual user interface elements.

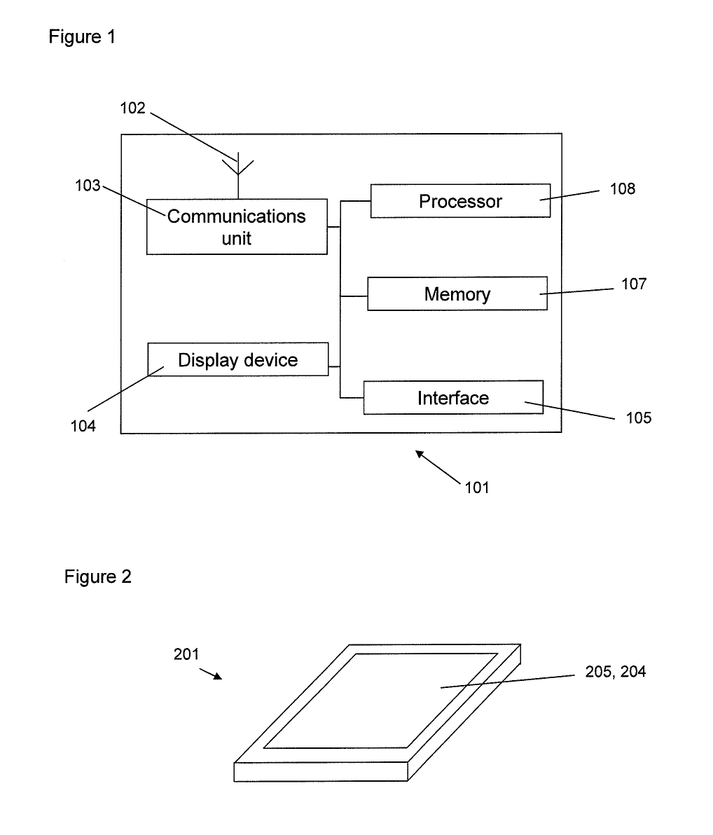

FIG. 1 depicts an apparatus (101) of an example embodiment, such as a mobile phone. In other example embodiments, the apparatus (101) may comprise a module for a mobile phone (or PDA or audio/video player), and may just comprise a suitably configured memory (107) and processor (108).

The example embodiment of FIG. 1, in this case, comprises a display device (104) such as, for example, a Liquid Crystal Display (LCD) or touch-screen user interface. The apparatus (101) of FIG. 1 is configured such that it may receive, include, and/or otherwise access data. For example, this example embodiment (101) comprises a communications unit (103), such as a receiver, transmitter, and/or transceiver, in communication with an antenna (102) for connecting to a wireless network and/or a port (not shown) for accepting a physical connection to a network, such that data may be received via one or more types of networks. This example embodiment comprises a memory (107) that stores data, possibly after being received via antenna (102) or port or after being generated at the user interface (105). The processor (108) may receive data from the user interface (105), from the memory (107), or from the communication unit (103). It will be appreciated that, in certain example embodiments, the display device (104) may incorporate the user interface (105). Regardless of the origin of the data, these data may be outputted to a user of apparatus (101) via the display device (104), and/or any other output devices provided with apparatus. The processor (108) may also store the data for later user in the memory (107). The memory (107) may store computer program code and/or applications which may be used to instruct/enable the processor (108) to perform functions (e.g. read, write, delete, edit or process data).

FIG. 2 depicts an example embodiment of the apparatus comprising a portable electronic device (201), e.g. such as a mobile phone, with a user interface comprising a touch-screen user interface (205, 204), a memory (not shown), a processor (not shown) and an antenna (not shown) for transmitting and/or receiving data (e.g. emails, textual messages, phone calls, information corresponding to web pages).

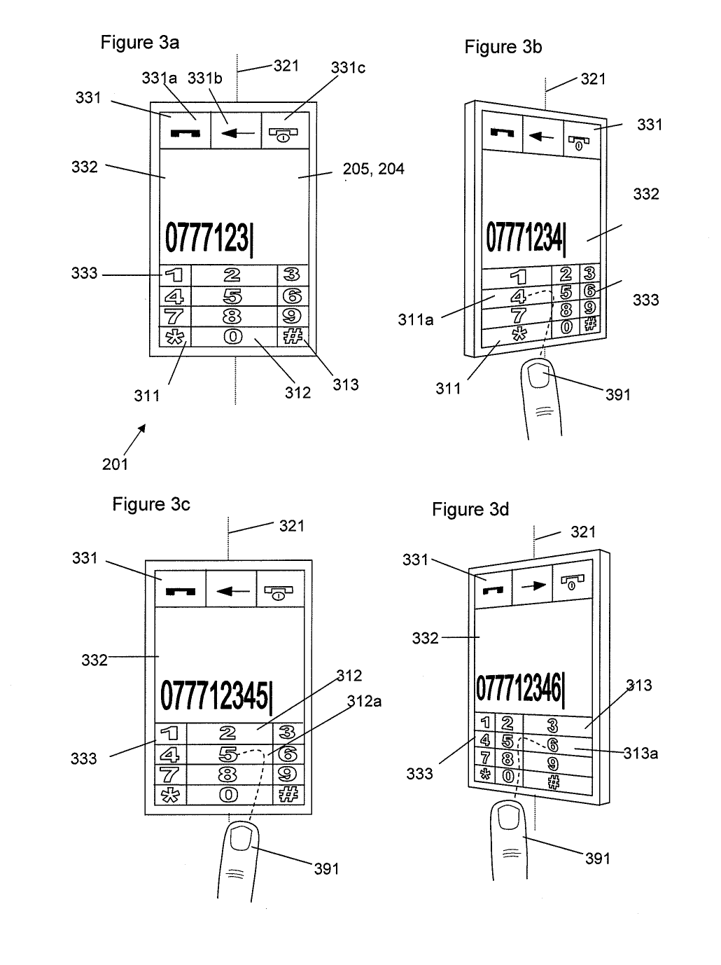

FIG. 3a-d illustrates a series of views of the example embodiment of FIG. 2 when the mobile phone device (201) is in use. In this example, the user wants to enter the telephone number ‘0777 123 456’.

To facilitate the entering of phone numbers, this example embodiment has an telephone mode wherein the touch-screen user interface (205) is divided into three regions: a virtual keypad region (333) comprising a number of key user interaction elements (corresponding to the digits 1-9 and the characters ‘*’ and ‘#’); a number entry region (332) which is configured to display the one or more entered digits; and a icon region (331) comprising icons (331a, 331b and 331c) which allow the user to control the device. The icons in this case comprise a call initiate icon (331a), a hang-up icon (331c) and a back key (331b).

In this case the virtual keypad graphical user interface comprises three predefined constituent portions (311, 312 and 313) each comprising multiple user interface elements: the left constituent portion comprising the ‘7’, ‘4’, ‘1’, and ‘*’ keys; the central constituent portion comprising the ‘8’, ‘5’, ‘2’, and ‘0’ keys; and the right constituent portion comprising the ‘9’, ‘6’, ‘3’, and ‘#’ keys. In this case, the constituent portions of the virtual keypad graphical user interface are mutually exclusive in that no individual key user interface element forms part of more than one graphical user interface constituent portion. It will be appreciated that for other example embodiments, the constituent portions may not be mutually exclusive. In this case, the boundaries of the individual key user interface elements are visible as lines surrounding each key indicium (the indicium in this case denoting the corresponding character).

For this example embodiment a constituent portion of the graphical user interface may be selected (and deselected) by tilting the device about a longitudinal axis (321). It will be appreciated that the apparatus may be configured to detect the tilt using, for example, an accelerometer or a tilt sensor (e.g. a tilt switch). It will be appreciated that other example embodiments may be configured to enable selection by detecting tilt about more than one axis.

In the situation depicted in FIG. 3a, the user has already opened the telephone mode. The user has already entered the digits ‘0777123’. The next digit he wishes to enter is ‘4’. In this case, the phone is orientated about the longitudinal axis to be flat. In this case the central constituent portion (312) is selected and the user interface elements of the selected central constituent portion have been enlarged. Although in this configuration, the user may directly select user interface elements not forming part of the selected portion, the user wishes to first enlarge the portion comprising the desired key in order to better, and unambiguously, select the desired key.

In order to enter the next desired digit ‘4’, the user tilts the phone about the longitudinal axis such that the left hand side of the phone is upwards. The apparatus is configured to detect the change in orientation about the longitudinal axis (321) and automatically select the left constituent portion (311) of the virtual keypad graphical user interface (333), and deselect any other selected constituent portions (in this case, the previously selected central portion is deselected). The device is then configured to enlarge the user interface elements of the selected left constituent portion (311) of the graphical user interface, as depicted in FIG. 3b. The enlargement in this case extends the lateral dimension of the user interface elements of the selected portion. The height of the user interface elements in the longitudinal direction remains unchanged in this example.

This example embodiment is also configured to reduce the size of the user interface elements which do not form part of the selected constituent portion. In this way, all of the user interface elements which were displayed before selection of a particular constituent portion remain interface visible on the graphical user interface. By retaining a representation of all of the user elements, the user may be better able to select the desired key user interface element by being able to recognise the relative position of the desired user interface elements with respect to other user interface elements. For example, the desired enlarged ‘4’ key user interface element remains positioned to the left of the visible (non-enlarged) ‘5’ key user interface element.

Enlarging the key user interface elements of the selected portion allows the user to more easily select unambiguously the desired key user interface element (311a) by touching the screen with a stylus (391) within the enlarged desired digit user interface element (e.g. within the visible boundary). In this case, the stylus is the user's finger (391). When the desired key user interface element is selected the device is configured to enter the corresponding digit to the number entered in the number entry region (332).

In some example embodiments, user interface elements may be selectable only when enlarged. On other example embodiments, user interface elements are selectable regardless of whether they are enlarged or not.

In order to enter the next desired digit, ‘5’, the user tilts the phone such that the phone is level about the longitudinal axis. In response to detecting the angle about the longitudinal axis, the device is configured to select the central constituent portion (312) of the virtual keypad graphical user interface (333). This has the effect of enlarging the user interface elements of the selected central constituent portion (312) of the graphical user interface, as depicted in FIG. 3b. This allows the user to more easily select unambiguously the desired key user interface element (312a) by touching the screen (304) with a stylus (391) within the enlarged desired digit user interface element. When the desired key user interface element is selected the device is configured to enter the corresponding digit to the number entered in the number entry region (332).

In order to enter the next desired digit ‘6’, the user tilts the phone such that the right hand side of the phone is upwards. This selects the right constituent portion (313) of the virtual keypad graphical user interface (333). This has the effect of enlarging the user interface elements of the selected right constituent portion (313) of the graphical user interface, as depicted in FIG. 3b. This allows the user to more easily select unambiguously the desired digit user interface element (313a) by touching the screen (304) with a stylus (391) within the enlarged desired digit user interface element. When the desired key user interface element is selected the device is configured to enter the corresponding digit to the number entered in the number entry region (332).

When the number is complete, the user can initiate a call to that number by pressing the initiate call icon (331a) from the icon region of the graphical user interface.

For this example embodiment, the enlargement is a one-dimensional enlargement (i.e. the user interface elements are stretched in one direction only). It will be appreciated that for other example embodiments, the enlargement may be a two-dimensional enlargement (or three-dimensional). It will be appreciated that the enlargement in two dimensions may or may not be the same (e.g. the user interface element may be enlarged by a factor of 2 along an x-axis and a factor of 1.5 along a y-axis). It will be appreciated that the enlargement may be a deformation which increases at least one parameter of the user interface's size (e.g. length, height, width, area or other dimension).

For this example embodiment, the device is configured to detect tilt about a single longitudinal axis. It will be appreciated that other example embodiments may be able to detect tilt about a plurality of axis. It will be appreciated that other example embodiments may use different sensors to determine tilt (e.g. a gyroscope).

For this example embodiment, the user interface elements are virtual keys on a numerical keypad. It will be appreciated that for other example embodiments, the user interface elements may be, for example, other characters, icons or menu items.

For this example embodiment, the user interacts directly with the graphical user interface using a stylus. It will be appreciated that for other user interfaces, the user may interact indirectly with the graphical user interface. For example, the user may use a mouse, keys, pointing stick or wand to control a cursor on the graphical user interface.

It will be appreciated that other example embodiments may have a single selectable constituent portion.

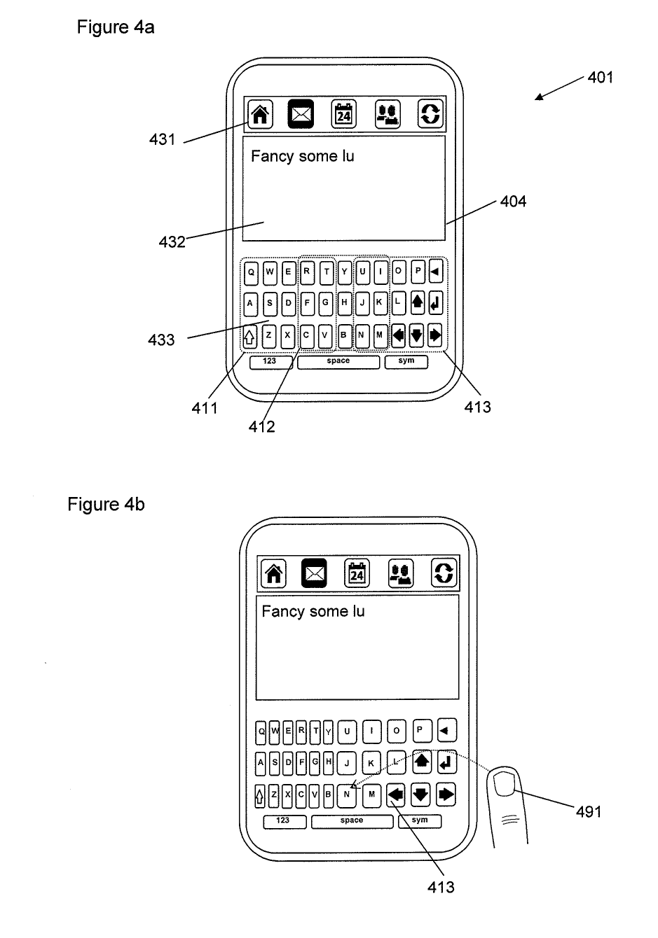

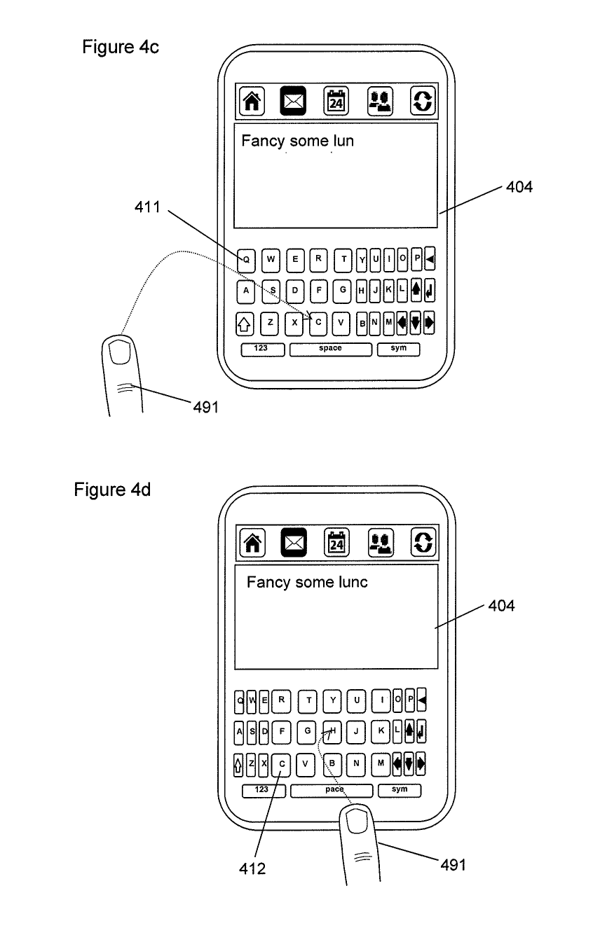

FIG. 4a illustrates a further example embodiment (401) of an apparatus such as a personal digital assistant device (or a tablet PC) comprising a capacitive touch screen (404) configured to display a graphical user interface. In the situation depicted in FIG. 4a the user has entered an email mode of the device. In the email mode, the user interface comprises an icon region (431), an entered text region (432) and a key user interface (433) which, in this case, is a virtual QWERTY keyboard.

In this example, the user wishes to enter the text ‘fancy some lunch?’ and email it to a friend. In the situation depicted in FIG. 4a, the user has already entered the characters corresponding to the text ‘fancy some lu’ into the entered text region (432) of the screen.

For this example embodiment the virtual keypad comprises three predefined (overlapping) selectable constituent portions (411, 412, 413), each constituent portion comprising a plurality of user interface elements: a left constituent portion comprising inclusively the key user interface elements between the ‘Q’, ‘T’, shift ‘ [symbol] ’, and ‘V’ key user interface elements; a central constituent portion comprising inclusively the key user interface elements between the ‘R’, ‘I’, ‘C’, and ‘M’ key user interface elements; and a right constituent portion comprising inclusively the key user interface elements between the ‘U’, back ‘ [symbol] ’, ‘N’, and right arrow ‘→’ key user interface elements. Unlike the previous example embodiment, where the constituent portions of the graphical user interface are mutually exclusive (e.g. overlapping), in this case, the constituent portions in this example embodiment are not mutually exclusive. For example, the ‘I’ key user interface element forms part of the central constituent portion (412) and part of the right constituent (413) portion.

For this example embodiment, the apparatus is configured to detect the position of a stylus (491) when proximate to the capacitive touch screen (404) to enable selection (e.g. when the stylus is hovering near the screen). In this example embodiment, the stylus comprises the user's finger. For this example embodiment, the apparatus is configured to detect the proximity and position of the stylus (491) using capacitance determinations. It will be appreciated that other example embodiments may use other sensors, such as an infrared transceiver or a camera to determine the proximity and position of the stylus.

In this example, the user wishes to enter the letter ‘n’. In this case, the ‘N’ key user interface element forms part of the central constituent portion (412) and of the right constituent portion (413). As depicted in FIG. 4b, the user selects the right hand constituent portion (413) by ‘hovering’ his finger over the right hand constituent portion of the screen (e.g. in this case, the selection is based on the initial position of the finger within the constituent portions of the graphical user interface when no constituent portions are selected). The device is then configured to enlarge the user interface elements of the selected right hand constituent portion (413) (i.e. relative to the size they were before selection) and reduce the size of the user interface elements which do not form part of the selected constituent portion. In this way, all of the user interface elements which were displayed before selection of a particular constituent portion remain visible on the graphical user interface. By retaining a representation of all of the user elements, the user may be better able to select the desired key by being able to recognise the relative position of the desired user interface elements with respect to other user interface elements.

The user may then select the desired character from the enlarged user interface elements of the selected constituent portion. In this case, the key user interface element ‘N’ is selected and the corresponding character ‘n’ is entered into the entered text region (432) of the graphical user interface. The user then removes his finger (491) from the touch screen (404). The apparatus in this case is then configured to deselect the selected constituent portion in response to the stylus no longer being detected and return the graphical user interface to the configuration depicted in FIG. 4a. It will be appreciated that the user interface elements not forming part of a selected constituent portion may or may not be selectable.

The user then wishes to enter the letter ‘c’. In this case, the ‘C’ key user interface element forms part of the central constituent portion (412) and of the left constituent portion (411). As depicted in FIG. 4c, the user selects the left constituent portion by hovering his finger over the left constituent portion of the screen when there are no portions selected. The device is then configured to enlarge the user interface elements of the left hand constituent portion (411) (i.e. relative to the size they were before selection) and reduce the size of the user interface elements which do not form part of the selected constituent portion. In this case, the desired letter ‘c’ is selected by the user and entered into the entered text region of the graphical user interface. The user then removes his finger from the touch screen device which returns the graphical user interface to the configuration depicted in FIG. 4a.

The user then wishes to enter the letter ‘h’. In this case, the ‘H’ key user interface element forms part of the central constituent portion (412) and of the left constituent portion (411). As depicted in FIG. 4c, the user selects the central constituent portion by hovering his finger over the central region of the screen. The device is then configured to enlarge the user interface elements of the central constituent portion (412) (i.e. relative to the size they were before selection) and reduce the size of the user interface elements which do not form part of the selected constituent portion. In this case, the desired letter ‘h’ is selected by the user and entered into the entered text region of the graphical user interface. The user then removes his finger (491) from the touch screen (404) which returns the graphical user interface to the configuration depicted in FIG. 4a.

In this way, the user can select the desired series of characters and enter the desired message. It will be appreciated that hovering may comprise: hovering above a constituent portion without touching the constituent potion; or hovering above a constituent potion whilst touching the constituent potion. In the latter case, for example, selection of a particular user interface element may be based on detecting a push entry over the particular user interface element, or no longer detecting touch over the particular user interface element.

It will be appreciated that advantages of the described example embodiments may include that the device (e.g. phone or PDA) may be made smaller which may make it easier to hold and to fit in a pocket, while preserving easy and ergonomic input (e.g. textual input). In addition, it may allow a full keypad to be used (e.g. rather than a reduced keypad), thereby reducing the need for a single user interface element to correspond to multiple functions (e.g. multiple characters as in the case with the predictive text keyboards). This may allow character entry to require fewer key presses, and be more intuitive and easier. By reducing the need for the user to enter ambiguous key sequences, the accuracy of the input method may also be increased.

It will be appreciated that, in this example embodiment, the entire virtual QWERTY-keyboard can be accommodated and used while holding the device in portrait orientation. In this orientation, the screen is often fairly narrow which may make the device more comfortable to hold. Enlarging user interface elements corresponding to a selected constituent portion of the graphical user interface allows the user to unambiguously select the desired user interface element whilst retaining the device in the portrait configuration.

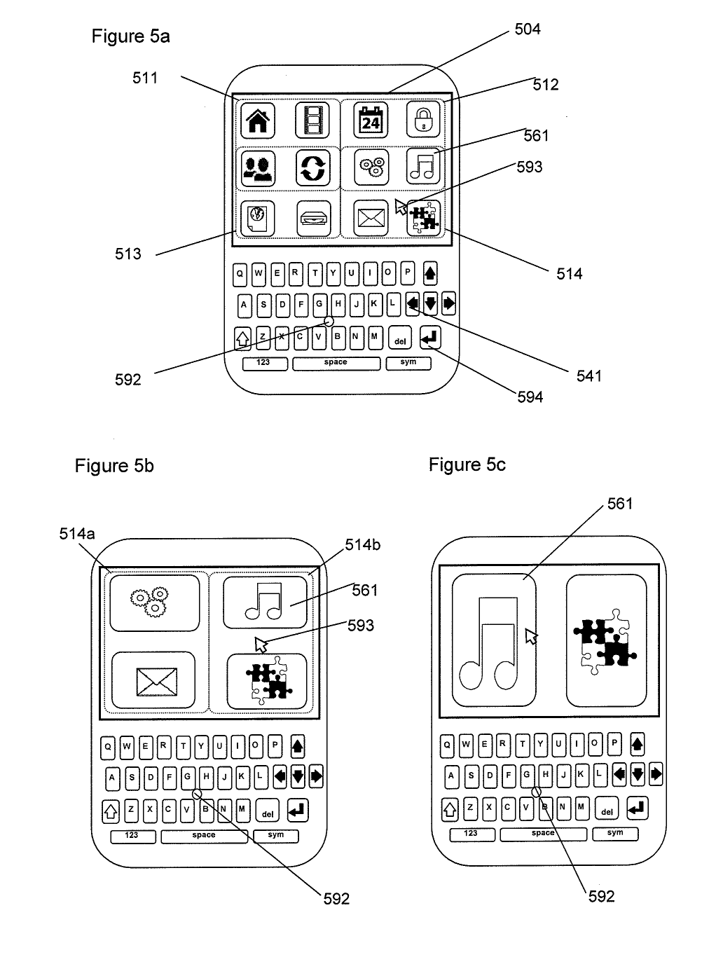

FIG. 5a illustrates a further example embodiment (501) of an apparatus such as a personal digital assistant device (or tablet PC) comprising a screen (504) configured to display a graphical user interface. Unlike previous example embodiments, which each comprised a virtual keypad, this example embodiment comprises a physical keyboard (541) and a pointing stick (592) configured to allow the user to control a cursor (593). That is, for this example embodiment the user interacts with the graphical user interface indirectly using a pointing stick (592) to control a cursor (593) on the screen (504).

In this example, the user wishes to open a MP3 music player application by selecting the corresponding music player icon user interface element (561).

In the situation depicted in FIG. 5a, the user is presented with a graphical user interface comprising a 3 by 4 array of icon user interface elements. In this case the 3 by 4 array of icon user interface elements comprise four (overlapping) constituent portions (511, 512, 513 and 514), each constituent portion comprising a 2 by 2 array of user interface elements. The top left constituent (511) portion comprises the icon user interface elements corresponding to a home screen, a movies folder, a messaging application and a deleted items folder. The top right constituent portion (512) comprises the icon user interface elements corresponding to a calendar application, a link to preferences, a link to settings and the MP3 music player application (561). The bottom left constituent portion (513) comprises the icon user interface elements corresponding to the messaging application, the deleted items folder, a web browser application and a disk drive folder. The bottom right constituent portion (514) comprises the icon user interface elements corresponding to the link to settings, the MP3 music player application (561), a mail application and a games folder.

In this case the user can select any one of the displayed icons by directly positioning the cursor (593) within the boundary of the desired icon and pressing a selection key (e.g. pressing the enter key (594) or depressing pointing stick (592)). However, if, for example, the user is unsure of the nature of the icons (e.g. if the indicia denoting the function of the icon is too small to see clearly), or cannot control the cursor with sufficient precision, the user can press the selection key when the cursor is not positioned within the boundaries of an icon user interface element. In this case, this will select the constituent portion which has its centre closest to the position of the cursor when the selection key is pressed. In the situation depicted in FIG. 5a, pressing the selection key allows the user to select the bottom right constituent portion (514) of the graphical user interface.

As depicted in FIG. 5b, when the bottom right constituent portion (514) has been selected the user interface elements of the selected constituent portion (514) are enlarged. Unlike the previous example embodiments, where the user interface elements not belonging to the selection constituent portion are reduced in size, in this example embodiment, the non-selected user interface elements are no longer displayed on the screen. This allows the user interface elements of the selected constituent portion to be enlarged to take up the full area of the screen (504).

For this example embodiment, the selected enlarged constituent portion of the original user interface is again subdivided into two further constituent portions (a right constituent portion (514a) and a left constituent portion (514b)), each of the further constituent portions comprising multiple user interface elements. In this case, the further constituent portions are mutually exclusive. As with the situation depicted in FIG. 5a, the user can directly select any of the displayed user interface elements. Also, as with the situation depicted in FIG. 5a, the user can also select a constituent portion by pressing the selection key when the cursor is not positioned within a boundary of an icon user interface element. In this case, the user presses the selection button when the cursor is between the games folder icon and the music player application icon (561), thereby selecting the right constituent portion (514b) of the graphical user interface.

The icon user interface elements of the selected constituent portion are then enlarged. In this example, the icon user interface elements which do not form part of the selected constituent portion are no longer displayed. Unlike for the previous example embodiments, where the enlargement of the user interface elements retained the relative positions of each of the user interface elements upon enlargement, in this example, the relative positions of the user interface elements are adjusted. That is, in this example, whereas before enlargement the music player application icon was positioned above the games folder icon, after enlargements, the music player application icon is positioned to the left of the games folder icon. This may allow the icons to be arranged such that the make the more efficient use of the available space.

The user may then select the desired music player application user interface element by positioning the cursor within the boundary of the music player application user interface element and pressing the selection key (594).

By using iterations of selecting and enlarging, the user can keep enlarging constituent portions of the displayed graphical user interface until the desired user interface element may be unambiguously selected.

It will be appreciated that for other example embodiments, a constituent portion may be defined by the user. For example, the user may define a constituent portion by selecting a plurality of user interface elements (e.g. by drawing a boundary around the icons making up the user defined portion).

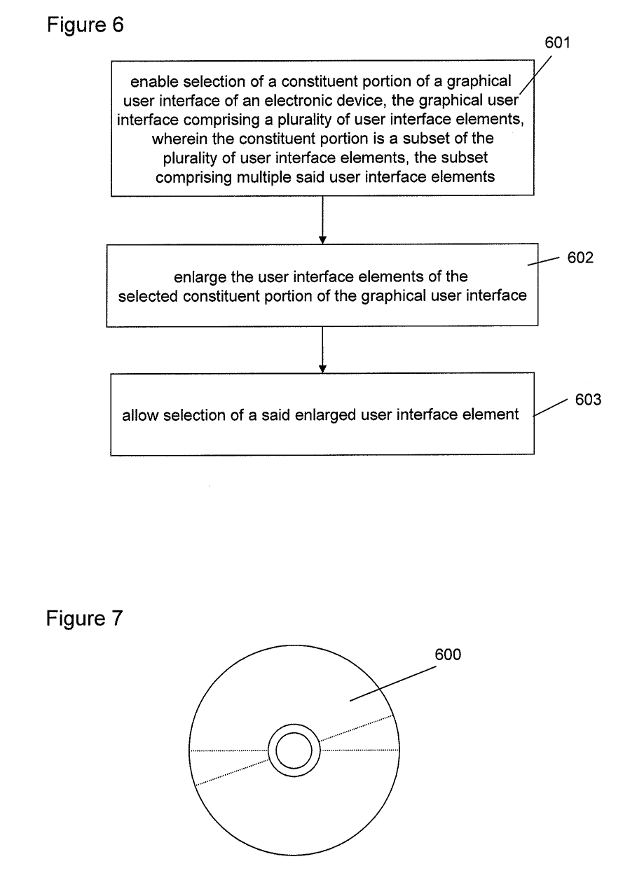

FIG. 6 shows a flow diagram illustrating the enlargement and selection of a user interface element, and is self-explanatory.

FIG. 7 illustrates schematically a computer/processor readable media 500 providing a program according to an example embodiment of the present invention. In this example, the computer/processor readable media is a disc such as a digital versatile disc (DVD) or a compact disc (CD). In other example embodiments, the computer readable media may be any media that has been programmed in such a way as to carry out an inventive function.

It will be appreciated to the skilled reader that any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some example embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such example embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some example embodiments one or more of any mentioned processors may be distributed over a plurality of devices. The same or different processor/processing elements may perform one or more functions described herein.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/example embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred example embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or example embodiment of the invention may be incorporated in any other disclosed or described or suggested form or example embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
enable selection of a constituent portion of a graphical user interface of an electronic device, the graphical user interface comprising a plurality of user interface elements, wherein the constituent portion is a subset of the plurality of user interface elements, the subset comprising multiple said user interface elements;
enlarge the user interface elements of the selected constituent portion of the graphical user interface; and
allow selection of a said enlarged user interface element.

2. The apparatus of claim 1, wherein the graphical user interface comprises a combination of one or more of a virtual keyboard, a menu, an 1D array of user interface elements, a 2D array of user interface elements, and a 3D array of user interface elements.

3. The apparatus of claim 1, wherein each constituent portion comprises a 1D array of user interface elements, a 2D array of user interface elements, or a 3D array of user interface elements.

4. The apparatus of claim 1, wherein a said user interface element comprises a key, an icon, or a menu item.

5. The apparatus of claim 1, wherein the apparatus is configured to:
reduce the size of the user interface elements which do not form part of the enlarged selected constituent portion of the graphical user interface element.

6. The apparatus of claim 1, wherein the apparatus is configured to:
adjust the size of the non-enlarged user interface elements such that all of the user interface elements visible before selection remain visible after selection and enlargement.

7. The apparatus of claim 1, wherein the apparatus is configured to:
remove from view the user interface elements which do not form part of the selected constituent portion.

8. The apparatus of claim 1, wherein each said user interface element forms part of only one constituent portion.

9. The apparatus of claim 1, wherein the relative positions of the user interface elements of the selected constituent portion are the same before and after enlargement.

10. The apparatus of claim 1, wherein selection of the constituent portion of the graphical user interface comprises:
detecting a particular stylus position from a plurality of detectable stylus positions of the electronic device, each stylus position being associated with a constituent portion of the graphical user interface.

11. The apparatus of claim 1, wherein selection of the constituent portion of the graphical user interface comprises:
detecting a particular cursor position from a plurality of detectable cursor positions of the electronic device, each cursor position being associated with a constituent portion of the graphical user interface.

12. The apparatus of claim 1, wherein selection of the constituent portion of the graphical user interface comprises:
detecting an particular orientation from a plurality of detectable orientations of the electronic device, each orientation being associated with a constituent portion of the graphical user interface.

13. The apparatus of claim 1, wherein selection of the constituent portion of the graphical user interface comprises:
detecting a selection input.

14. The apparatus of claim 1, wherein selection of the constituent portion of the graphical user interface comprises:
detecting a tilt of the electronic device, from a plurality of detectable tilts of the electronic device, each tilt being associated with a constituent portion of the graphical user interface.

15. The apparatus of claim 1, wherein the graphical user interface comprises multiple constituent portions.

16. The apparatus of claim 1, wherein the multiple user interface element forming a said constituent portion are predefined.

17. The apparatus according to claim 1, wherein the apparatus is at least one of a portable electronic device, circuitry for a portable electronic device, a laptop computer, a desktop computer, a mobile phone, a Smartphone, a tablet PC, a monitor, a personal digital assistant or a digital camera or a module for the same.

18. The apparatus of claim 1, wherein the graphical user interface forms part of a user interface, and wherein the user interface comprises a combination of one or more of a wand, a pointing stick, a touchpad, a touch-screen, a stylus and pad, a mouse, a physical keyboard, a virtual keyboard, a joystick, a remote controller, a button, a microphone, a motion detector, a position detector, a scriber and an accelerometer.

19. A method, the method comprising:
enabling selection of a constituent portion of a graphical user interface of an electronic device, the graphical user interface comprising a plurality of user interface elements, wherein the constituent portion is a subset of the plurality of user interface elements, the subset comprising multiple said user interface elements;
enlarging the user interface elements of the selected constituent portion of the graphical user interface; and
allowing selection of a said enlarged user interface element.

20. A computer program, the computer program comprising computer program code configured to:
enable selection of a constituent portion of a graphical user interface of an electronic device, the graphical user interface comprising a plurality of user interface elements, wherein the constituent portion is a subset of the plurality of user interface elements, the subset comprising multiple said user interface elements;
enlarge the user interface elements of the selected constituent portion of the graphical user interface; and
allow selection of a said enlarged user interface element.
